(19) United States
(12) Patent Application Publication
(10) Pub. No.: US 2016/0047141 A1
(43) Pub. Date: Feb. 18, 2016

(54) A Barricade System

(71) Applicant: Ben JUETT, Oxenford, Queensland (AU)

(72) Inventor: Ben Juett, Loganholme (AU)

(21) Appl. No.: 14/779,962

(22) PCT Filed: Mar. 26, 2014
(86) PCT No.: PCT/AU2014/000313

§ 371 Date: Sep. 24, 2015

(30) Foreign Application Priority Data
Mar. 26, 2013 (AU) 2013901043

(51) Int. Cl. E04H 17/18; E06B 11/02; E05C 1/10; E05B 65/00; E05D 15/26; E04H 17/16; E06B 11/04

(52) U.S. Cl. CPC E04H 17/18; E04H 17/165; E06B 11/022; E06B 11/04; E05B 65/0007; E05D 15/266; E05C 1/10

(57) ABSTRACT

A barricade system comprises a barrier assembly, a floor assembly, a floor locking assembly, and a manipulating assembly configured for engagement with the floor locking assembly. The barrier assembly is collapsible and defines an enclosure when erected. The floor assembly is configured for location within the enclosure and removal from the enclosure. The barrier assembly supports the floor assembly. The floor locking assembly is operable between a locked condition in which the floor assembly is locked to the barrier assembly and an unlocked condition in which the floor assembly can be removed from the enclosure. The manipulating assembly engages with the floor locking assembly to operate the floor locking assembly to unlock the floor assembly. The manipulating assembly and floor locking assembly being configured so that engagement of the manipulating assembly with the floor locking assembly is substantially limited to a condition in which the barrier assembly is erected.

### SUMMARY

The following is a broad summary of various exemplary embodiments of a barricade system. As such, it is provided solely for the purposes of enhancing the clarity of the specification. It is not intended to limit the scope of the appended claims.

Various exemplary embodiments of the barricade system comprise

a collapsible barrier assembly that defines an enclosure when erected;

a floor assembly that is configured for location within the enclosure and removal from the enclosure, when the barrier assembly is erected such that the floor assembly spans the enclosure, in use, the barrier assembly being configured to support the floor assembly when erected;

at least one releasable floor locking assembly that is capable of operative engagement with the barrier assembly and floor assembly and operable between a locked condition in which the floor assembly is locked to the barrier assembly and an unlocked condition in which the floor assembly can be removed from the enclosure; and at least one manipulating assembly configured for engagement with the floor locking assembly to permit a user to operate the floor locking assembly to unlock the floor assembly, the manipulating assembly and floor locking assembly being configured so that engagement of the manipulating assembly with the floor locking assembly is substantially limited to a condition in which the barrier assembly is erected and access to the enclosure is inhibited.

Thus, the barricade system can be used when it is necessary to guard a particular area into which access is required to be restricted. Such an area can be a location in which excavation is about to take place or has taken place, so leaving a pit or hole or trench which could be dangerous if left unguarded. The inventor(s) envisages that the barricade system can also be used in various locations, such as building construction sites, where it is necessary to provide a temporary barricade. Further examples are open service entries such as manholes or the like. It will readily be appreciated that the barricade system can be used to protect personnel working within and outside the enclosure.

The barrier assembly may include four panel assemblies that are hinged together so that the barrier assembly can be collapsed. The four panel assemblies may be hinged together so that the barrier assembly can be collapsed into a generally flat condition for storage or transport. One of the panel assemblies may be a gate assembly so that controlled access to the enclosure is facilitated.

The barricade system may include one or two or more releasable floor locking assemblies and one or two or more corresponding manipulating assemblies.

In use, the panel assemblies are pivoted with respect to each other into an erected condition. In that condition, the manipulating assemblies are used to manipulate the locking assembly or assemblies into an unlocked condition. The floor assembly is then positioned within the enclosure. The manipulating assemblies are then used to manipulate the locking assembly or assemblies into the locked condition to engage or lock the floor assembly in position. In the event that one of the panel assemblies is removed or the panel assemblies move out of the erected condition, for some reason, such as damage resulting from being struck by equipment, the manipulating assembly or assemblies move out of engagement with the locking assembly or assemblies so that it is no longer possible to manipulate the locking assembly or assemblies. It follows that, in that condition, the floor assembly cannot be removed from the enclosure. This inhibits an operator from gaining access to the enclosure without the floor assembly in position.

The barricade system may include one or more releasable floor locking assemblies and one or more corresponding manipulating assemblies. One of the manipulating assemblies may be positioned on the gate assembly to correspond with a locking assembly. Thus, removal of the floor assembly is inhibited while the gate assembly is in its open condition.

The barrier assembly may include the gate assembly, a front panel assembly and a pair of side panel assemblies. These are named in that way for convenience. Each side panel assembly may include a floor support structure on which sides of the floor assembly can be supported within the enclosure, when the barrier assembly is erected.

Each panel assembly and the gate assembly may include a top rail, a bottom rail, a pair of side rails and an intermediate rail extending between the side rails. Reinforcing or structural rails or bars may be interposed between the intermediate rail and the top rail. The top, bottom and side rails may be formed of a length of tube bent or otherwise formed into a suitable shape. Each of the intermediate rails and structural rails may also be in the form of tubing.

Each floor support structure may extend between side rails relatively close to the bottom rail. Each floor support structure may be a length of angled metal or other suitable material with one web fastened to the side rails and another web defining a ledge, lip or shelf on which a corresponding side of the floor assembly can be supported.

The floor support structures may define a channel in which a side of the floor assembly can be received, by sliding, when the barrier assembly is erected. The floor locking assembly may be operable to obstruct an opening to the channel in the locked condition of the floor locking assembly. The, or each manipulating assembly may be positioned on a side rail to engage with the, or each respective, locking assembly when the panel carrying the support structure and the panel carrying the manipulating assembly are correctly oriented with respect to each other. For example, said correct orientation would be when the panels are substantially at right angles to each other.

The floor assembly may comprise at least one floor panel. The floor panel(s) may be in the form of a rectangular grate panels. In use, once the panels are erected, the grate panels are inserted between the side panels so that their sides are supported by the support structures. For example, the side panels can be slid along the respective ledges.

Each locking assembly may include an obstruction member such as a catch, pawl, dog or the like that is displaceable between an operative position in which it is received in a position obstructing a path for the floor panel to be released from the floor support structure and an inoperative position in which the obstruction member is lifted clear from the path. The obstruction member may be spring mounted to the support structure so that it is biased into the operative position.

An engagement formation or member extends from the obstruction member to engage with a complementary engagement formation or member of the manipulating assembly so that the manipulating assembly can be used to urge the obstruction member into the inoperative position.

The manipulating assembly may include a handle assembly that is mounted on an associated side rail in a displaceable manner. The handle assembly may include an elongate member, such as a rod that is mounted on, and displaceable with respect to, a bracket that is itself fastened to the side rail. One end of the rod may include or define a handle formation. The complementary engagement formation or member may extend from the elongate member to engage the engagement member that extends from the obstruction member. The bracket is mounted on the side rail such that the engagement members can no longer engage each other it the associated panel moves out of its erected position, which is generally at right angles to an adjacent panel carrying the support structure. Thus, in that condition, the manipulating assembly cannot be used to displace the obstruction member into its inoperative condition.

In further exemplary embodiments, the barricade system is suitable for barricading an elongated area, such as a trench or other elongated excavation. In those exemplary embodiments, one or more further pairs of side panel assemblies can be pivotally connected to the existing pair of side panel assemblies, thus providing a generally elongate structure when the panel assemblies are erected.

To that end, a supplementary support assembly can be provided to extend between the side panel assemblies. The supplementary support assembly can be configured to support the floor assembly in a location or orientation above a position of the floor assembly in the preceding embodiments. The supplementary support assembly can be a series of beams that can optionally be positioned across the enclosure and between the side panel assemblies. Each beam can have a locating formation or member so that the beams can be correctly located to support the floor panels. For example, the intermediate rails of the side panel assemblies may define a corresponding locating formation so that one of the beams can be correctly positioned to support adjacent edges of consecutive floor panels.

Each of the side panel assemblies may have a pair of inwardly facing locating members in which corners of the floor panels can be received. The locating members may be positioned so that the floor panels are inhibited from being slid out of position. For example, the locating members may be positioned so that an operator is normally required to lift one of the floor panels before the other floor panel can be manipulated.

Specific exemplary embodiments of the barricade system are described below with reference to the accompanying drawings. The following description is for illustrative purposes only and is not intended to limit the scope of the appended claims.

### DESCRIPTION OF DRAWINGS

FIG. 1 shows a three-dimensional view, from above, and behind, of an exemplary embodiment of a barricade system.

FIG. 2 shows a three-dimensional view, from above and in front, of the barricade system of FIG. 1.

FIG. 3 shows a three-dimensional view, from below and in front, of the barricade system of FIG. 1.

FIG. 4 shows a side view of the barricade system of FIG. 1.

FIG. 5 shows a front view of the barricade system of FIG. 1.

FIGS. 6, 7 and 8 show detailed three-dimensional views of a floor locking assembly and manipulating assembly of the barricade system of FIG. 1, with an obstruction member of the floor locking assembly in an operative position.

FIG. 9 shows a detailed three-dimensional view of a floor locking assembly and manipulating assembly of the barricade system of FIG. 1, with the obstruction member of the floor locking assembly lifted into an inoperative position.

FIG. 10 shows a detailed three-dimensional views of a floor locking assembly and manipulating assembly of the barricade system of FIG. 1, with the obstruction member of the floor locking assembly lifted into the inoperative position and the floor panel partially removed from the enclosure.

FIG. 11 shows a detailed three-dimensional view, from below, of part of the barricade system of FIG. 1.

FIG. 12 shows a three-dimensional view of the panel assemblies of the barricade system in a folded or collapsed condition.

FIG. 13 shows another three-dimensional view of the panel assemblies of the barricade system in a folded or collapsed condition.

FIG. 14 shows a three-dimensional view of a hinge assembly for the barricade system of either FIG. 1 or 18.

FIG. 15 shows an exploded three-dimensional view of the hinge assembly of FIG. 14.

FIG. 16 shows a three-dimensional view of another exemplary embodiment of a hinge assembly for the barricade system of either FIG. 1 or 18.

FIG. 17 shows a top view of the hinge assembly of FIG. 16.

FIG. 18 shows a three-dimensional view, from above, of an exemplary embodiment of a barricade system.

FIG. 19 shows a three-dimensional view, from below, of the barricade system of FIG. 18.

FIG. 20 shows a three-dimensional view of a structural stiffener member used with the barricade system of FIG. 18.

FIG. 21 shows a three-dimensional view of another structural stiffener member used with the barricade system of FIG. 18.

FIG. 22 shows a three-dimensional view of a latch of the barricade systems of FIGS. 1 and 18.

FIG. 23 shows an exploded three-dimensional view of the latch of FIG. 22.

FIG. 24 shows a three-dimensional view, from above and in front, of a floor panel of the barricade systems of FIGS. 1 and 18.

FIG. 25 shows a three-dimensional view, from below and in front, of the floor panel of FIG. 24.

FIG. 26 shows a three dimensional view, from above, of an exemplary embodiment of a barricade system.

FIG. 27 shows a three-dimensional view, from one side, of a structural support member used with the barricade system of FIG. 26.

FIG. 28 shows a detailed three-dimensional view, of part of an exemplary embodiment of a barricade system.

FIG. 29 shows a detailed three-dimensional view, of part of another exemplary embodiment of a barricade system.

FIG. 30 shows a three-dimensional view, from above, of an exemplary embodiment of a barricade system.

FIG. 31 shows a plan view of the barricade system of FIG. 30.

FIG. 32 shows a side view of the barricade system of FIG. 30.

FIG. 33 shows an exploded three-dimensional view of a floor panel assembly for the barricade system of FIG. 30.

FIG. 34 shows an assembled view of the floor panel assembly of FIG. 33.

FIG. 35 shows an exploded three-dimensional view of a hinge assembly for the barricade system of FIG. 30.

### DESCRIPTION OF EMBODIMENTS

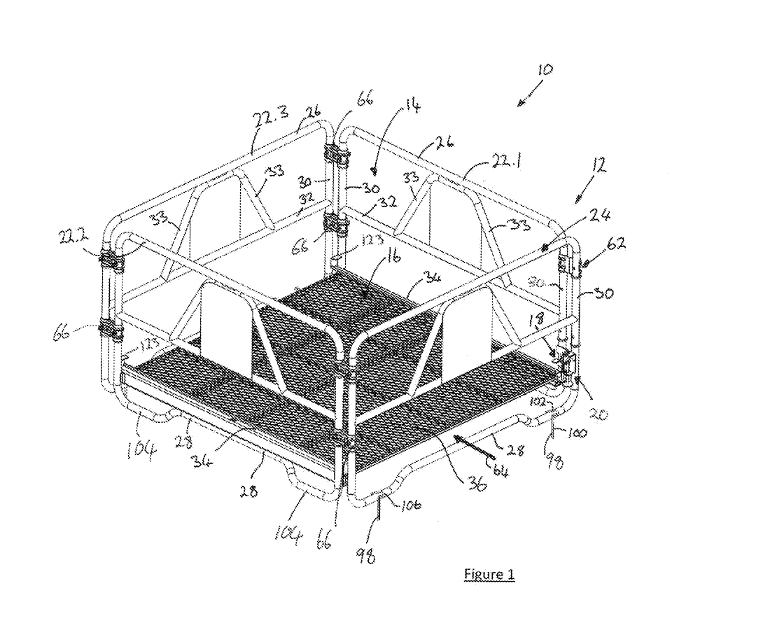

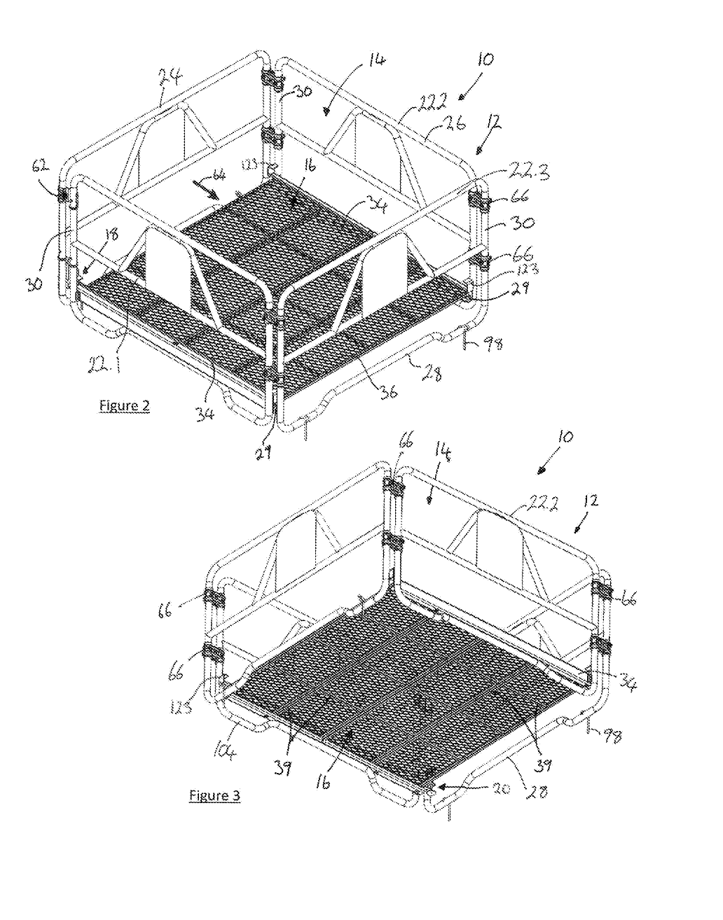

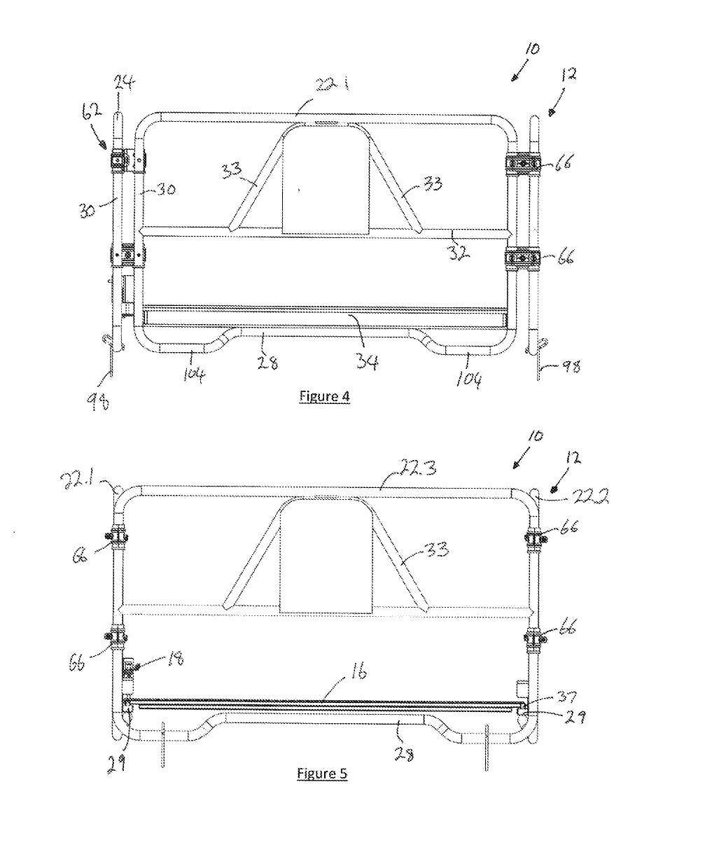

In FIGS. 1 to 5, an exemplary embodiment of a barricade system 10 is shown. In this exemplary embodiment, the barricade system 10 is suited for use with a generally non-elongate area that is required to be barricaded or protected from access. Such an area could be an excavation site or an area in a construction zone. The barricade system 10 can also be used to inhibit unauthorised access to a manhole, or the like, which is temporarily used for maintenance. For example, a manhole or other access point may be at street or pavement level. The barricade system 10 can be used to inhibit access by members of the public or can be used to support suitable warning arrangements to warn traffic and/or pedestrians of the existence of a potentially dangerous area.

The barricade system 10 includes a collapsible barrier assembly 12. The barrier assembly 12 defines an enclosure 14 when erected. The barrier assembly 12 includes a floor assembly 16 that is configured for location within the enclosure 14 and also for removal from the enclosure 14, when the barrier assembly 12 is erected such that the floor assembly 16 spans the enclosure 14, in use. Furthermore, the barrier assembly 12 is configured to support the floor assembly 16 when erected.

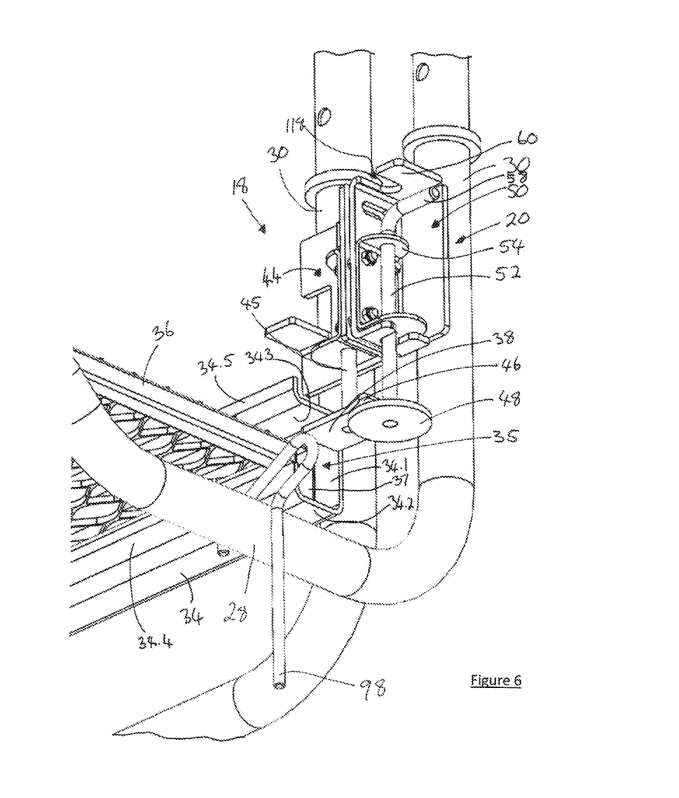

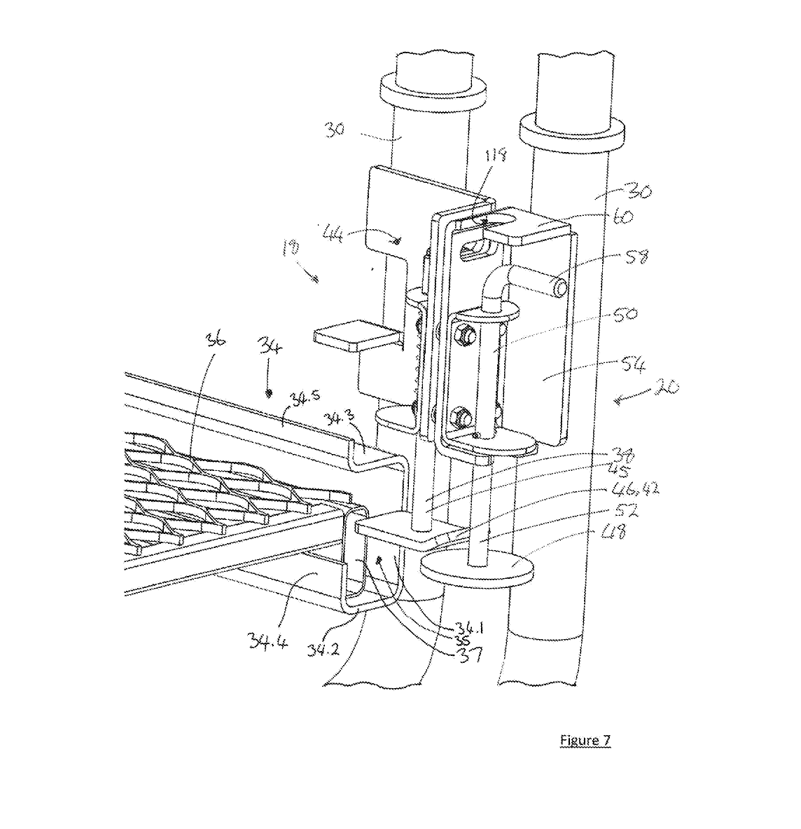

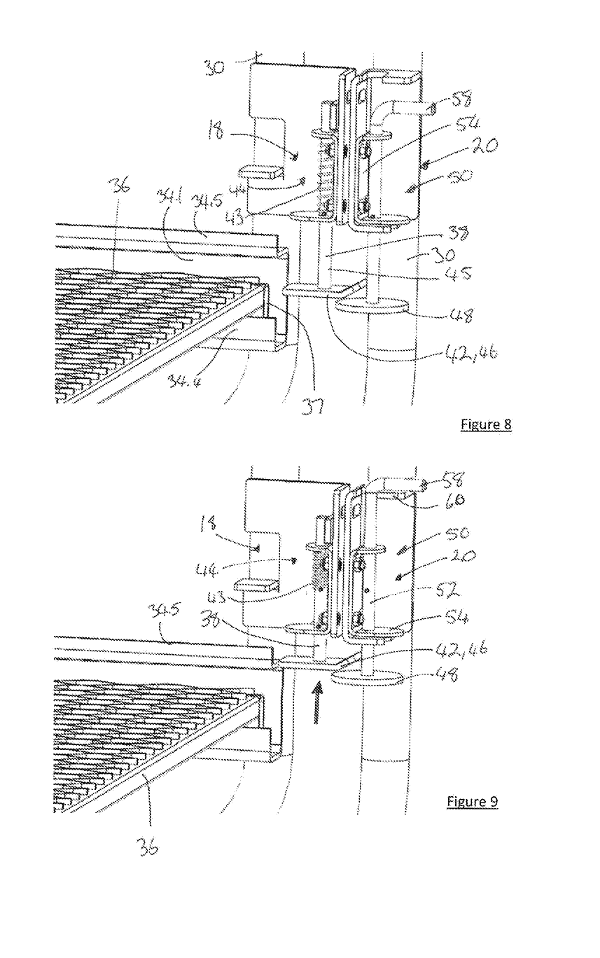

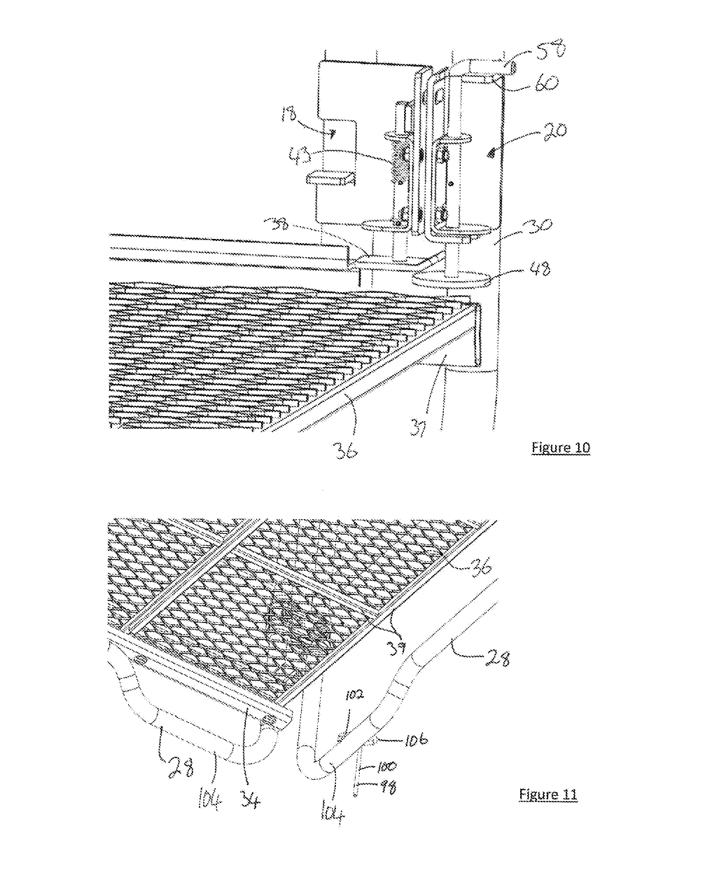

The system 10 includes a releasable floor locking assembly 18 that is capable of operative engagement with the barrier assembly 12 and floor assembly 16 and operable between a locked condition (FIGS. 6 to 8) in which the floor assembly 16 is locked to the barrier assembly 12 and an unlocked condition (FIGS. 9 and 10) in which the floor assembly 16 can be removed from the enclosure 14.

The system 10 includes a manipulating assembly 20 corresponding with the locking assembly 18. The manipulating assembly 20 is configured for engagement with the floor locking assembly 18 to operate the floor locking assembly 18 to release the floor assembly 16. The manipulating and floor locking assemblies 20, 18 are configured so that engagement of the manipulating assembly 20 with associated floor locking assembly 18 is substantially limited to a condition in which the barrier assembly 12 is in an erected condition and access to the enclosure 14 is inhibited.

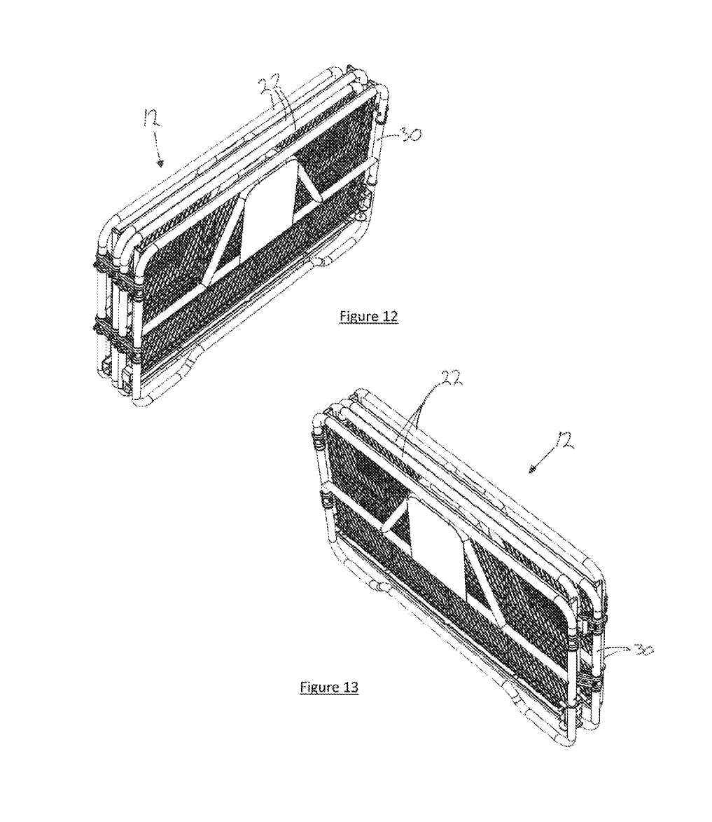

The barrier assembly 12 includes four panel assemblies 22. The panel assemblies 22 are hinged to each other so that the barrier assembly 12 can be collapsed into a substantially flat condition, as shown in FIGS. 12 and 13, for storage or transport.

One of the panel assemblies 22 is a gate assembly 24 to permit controlled access to the enclosure 14. The gate assembly 24 inhibits and access to the enclosure 14 when in a closed condition. The panel assemblies 22 include two, opposed side panel assemblies 22.1, 22.2 and a front panel assembly 22.3.

The manipulating assembly 20 is positioned on the gate assembly 24 to be opposite the locking assembly 18. Thus, removal of the floor assembly 16 is inhibited while the gate assembly 24 is in an open condition.

Each panel assembly 22 and gate assembly 24 includes a top rail 26, a bottom rail 28, a pair of side rails 30 and an intermediate rail 32 extending between the side rails 30. Reinforcing or structural rails 33 are interposed between the intermediate wall 32 and top rail 26. The top, bottom and side rails may each be formed of a length of bent tubing. The tubing may be of a metal. In one example, the tubing may be of aluminium. The inventor(s) envisages that the panel assemblies and gate assembly can also be of a plastics material, such as a reinforced plastics material. An example of a suitable reinforced plastics material is fibreglass reinforced plastics material.

Each of the side panel assemblies 22.1, 22.2 includes an elongate floor support structure 34. The support structure 34 extends between the side rails 30 of the side panel assemblies 22.1, 22.2. In one example (FIGS. 6 to 10), the floor support structure 34 includes a length of angled metal or other suitable material, such as a channel section with a side web 34.1 fastened to the side rails 30. The support structure includes a lower web 34.2 defining a ledge, lip or shelf on which a corresponding rail of the floor assembly 16 can be supported. Similarly, the support structure 34 includes an upper web 34.3 defining a ledge, lip or shelf on which a corresponding rail of the floor assembly 16 can be supported. The lower web 34.2 and upper web 34.3 each have an upstanding edge 34.4 and 34.5, respectively, along their inner sides. The side web 34.1 extends from the outer side of the lower web 34.2 to the outer side of the upper web 34.3. A channel 35 is defined between the side web 34.1, the lower web 34.2 and the upper web 34.3. The channels 35 are open at an end proximate the gate assembly 24. The support structure 34 includes stop formations 29 in the channels 35 at ends proximate the front panel assembly 22.3 (FIG. 5).

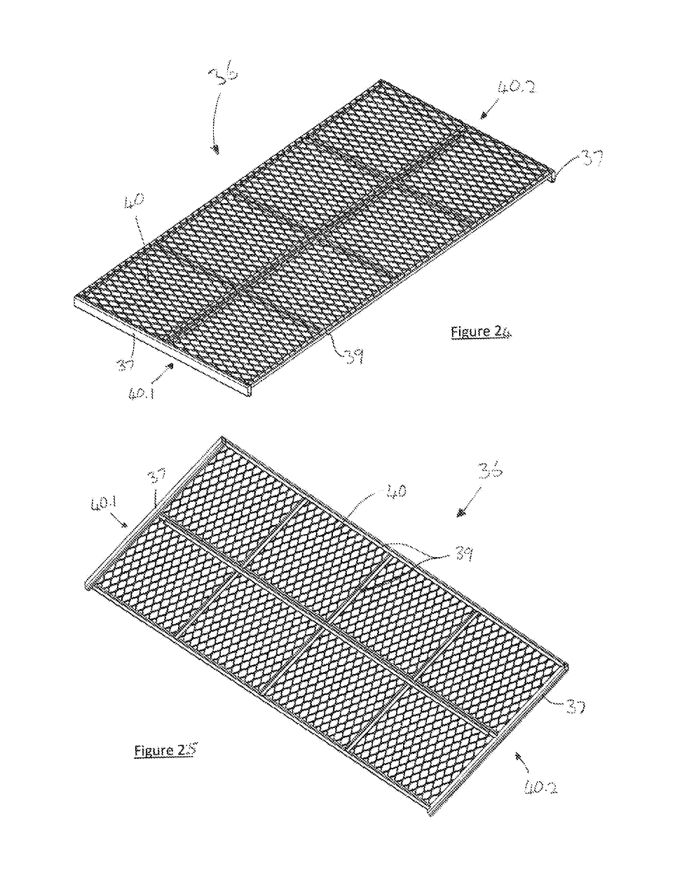

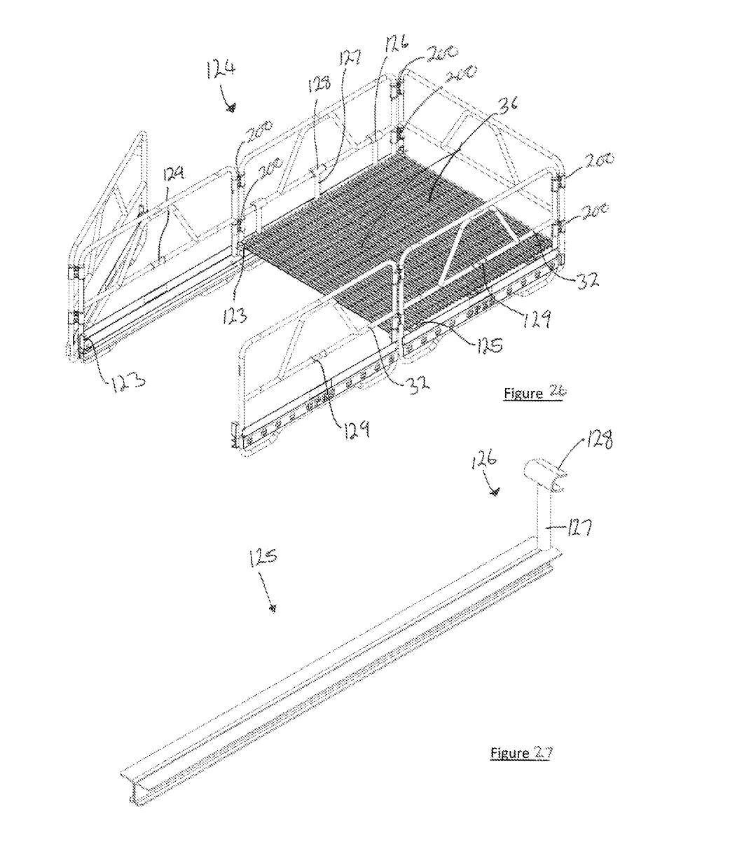

The floor assembly 16 may include one or more floor panels, in this embodiment two floor panels 36. Each floor panel 36 is a rectangular grate panel 40 having supporting ribs 39 and two skid rails 37 (FIGS. 24 and 25). Each skid rail 37 extends along one of two opposite sides of the grate panel 40. The skid rails 37 project downwardly from two opposite 40.1, 40.2 sides of the grate panel 40. The skid rails 37 are lengths of tubing. The skid rails 37 are dimensioned to be receivable in the channels 35 of the support structures 34.

In use, once the barrier assembly 12 is erected, the floor panels 36 are inserted between the side panel assemblies 22 in a configuration wherein the skid rails 37 of the floor panel 36 are received and are supported on either webs 34.2 or 34.3 as described in more detail herein below. The floor panel 36 can be of steel or aluminium. The grate panel 40 can, for example, be of steel mesh. Also, in one embodiment, the floor panel 36 can be of a plastics material. A suitable example would be a moulded plastics material. More particularly, but not exclusively, the material can be a reinforced plastics material, such as a fibreglass reinforced plastics material. In one embodiment, a suitable example is a material that is the product of a pultrusion process.

The panel assemblies 22 and the gate assembly 24 have substantially the same dimensions. It follows that the enclosure 14 is substantially square.

As detailed in FIGS. 6 to 10, the lock assembly 18 includes an obstruction member 38 in the form of a catch, pawl, dog or the like. The obstruction member 38 is displaceable between an operative position, as shown in FIGS. 6, 7 and 8, into an inoperative position, as shown in FIGS. 9 and 10. In the operative position, the obstruction member 38 obstructs the open end of the channel 35 of the floor support structure 34. The obstruction member 38 is at a height obstructing the floor panel 36 from being slid along a path outwardly out of the channel 35 of the floor support structure 34.

In the inoperative position, shown in FIG. 9, the obstruction member 38 is raised out of the way of the front opening of channel 35 of the floor support structure 34. FIG. 10 shows the obstruction member 38 in the inoperative position and the floor panel 36 slid partially out of the channel 35. In the inoperative position the obstruction member 38 is raised to a position clear of the top of the floor panel 36, as shown in FIG. 9, so that the floor panel 36 can be removed by sliding out of the channel 35, along a path as shown in FIG. 10.

The obstruction member 38 is mounted to the side rail 30 of the side panel assembly 22.1 via a bracket including a coil spring mounting mechanism 44. The obstruction member 38 includes a shank 45 and an engagement member 42 in the form of a foot 46 at a distal end of the shank 45. The coil spring mounting mechanism 44 includes a coil spring 43 which urges or biases the engagement member 42 into the operative position. The engagement member 42 is dimensioned and otherwise configured to engage with a complementary engagement formation or member 48 of the manipulating assembly 20 so that the manipulating assembly 20 can be used to urge the obstruction member 38 into the inoperative position.

The manipulating assembly 20 includes a handle assembly 50 that is mounted on an associated side rail 30 of the gate assembly 24. The handle assembly 50 includes a rod or bolt 52 that is held by a bracket 54 in a linearly displaceable manner.

The complementary engagement member 48 includes a disc-shaped lug, or the like, that extends from the bolt 52 on an operative side of the bracket 54. When the bolt 52 is in the condition shown in FIGS. 6, 7 and 8, the engagement member 48 can engage the member 42. Thus, when the bolt 52 is urged upwardly, as shown in FIGS. 9 and 10, so is the obstruction member 38.

The bolt 52 defines a handle formation 58 on an inoperative side of the bracket 54. This allows an operator to manipulate the bolt 52, and thus the obstruction member 38. The bracket 54 includes a catch or rest formation 60 on which the handle formation 58 is supported, as shown in FIGS. 9 and 10, when the bolt 52 is drawn up and the obstruction member 38 clears the top of the floor panel 36. Thus, when the barrier assembly 12 is erected, an operator is normally required to draw up the handle formation 58 and to rest it on the rest formation 60 before it is possible to remove the floor panel 36. The rest formation 60 defines a slot 61 in which the bolt 52 is received when the handle formation 58 is positioned on the rest formation 60.

In use, the panel assemblies 22 are manipulated, or unfolded, into their erected condition to define the enclosure 14 that encloses an area to be protected or guarded. The gate assembly 24 is closed with an appropriate latch mechanism 62. The obstruction member 38 is then manipulated with the handle assembly 50 in the manner described above such that the handle formation 58 is positioned on the rest formations 60. The grate panel 36 is then slid, in the direction of an arrow 64 (FIG. 1) into position with its skid rails 37 received in the channels 35 of the support structure 34. The handle formation 58 can then be released so that the obstruction member 38 snaps into the operative position, so securing the panel 36 from being removed from the enclosure 14, without again manipulating the bolt 52.

If the manipulating assembly 20 is somehow displaced away from the associated locking assembly 18, to a predetermined degree, it with no longer be possible for the obstruction member 38 to be manipulated into and out of its operative position. Thus, an operator is inhibited from removing the grate panel 36 when the gate assembly 24 is open.

In FIG. 28 there is shown further detail of an exemplary embodiment of a manipulating assembly 110 and a floor locking assembly 112. With reference to the preceding drawings, particularly FIGS. 6 to 10, like reference numbers refer to like parts, unless otherwise specified.

The obstruction member 38 is mounted to the web 34.1 via a torsional spring mounting mechanism 144. The obstruction member 38 includes a free end portion 38.1 that is received between the consecutive bars 142 of the floor panel 136. The obstruction member 38 includes a connecting portion 38.2 that extends angularly with respect to the portion 38.1 to connect to the mechanism 144. An engagement formation such as an engagement member 46 is arranged intermediate the free end portion 38.1 and the connecting portion 38.2. The engagement member 46 is dimensioned and otherwise configured to engage with a complementary engagement formation or member 48 of the manipulating assembly 110 so that the manipulating assembly 110 can be used to urge the obstruction member 38 into the inoperative position.

The manipulating assembly 110 includes a handle assembly 50 that is spring mounted on an associated side rail 30.2. The handle assembly 50 includes a rod or bolt 52 that is spring mounted on a bracket 54 via a suitable coil spring 56 so that the bolt 52 is biased into the position shown in FIG. 28.

The complementary engagement member 48 includes a lug, or the like, that extends from the bolt 52 on an operative side of the bracket 54. When the bolt 52 is in the condition shown in FIG. 28, the engagement member 48 can engage the member 46. Thus, when the bolt 52 is urged upwardly, so is the obstruction member 38.

As can be seen in FIG. 28, the connecting portion 38.2 of the obstruction member 38 has a bend or dogleg at 114. Thus, the upper web 34.3 defines a slot 116 to accommodate the dogleg 114 when the obstruction member 38 is displaced into the inoperative position.

In this embodiment, the bracket 54 incorporates a generally U-shaped support formation 120 that engages the side rail 30.2 of the gate assembly 24. A carrier portion 122 extends from the formation 120 to carry the handle assembly 50.

As can also be seen in the drawings, the bolt or rod 52 is of a length which is such that, when the rod 52 is in the operative position, it serves to obstruct movement of the grate panel 36. This is apparent in FIG. 28, where it is clear that movement of the panel 36 opposite to the direction of the arrow 64 would be inhibited by the rod 52.

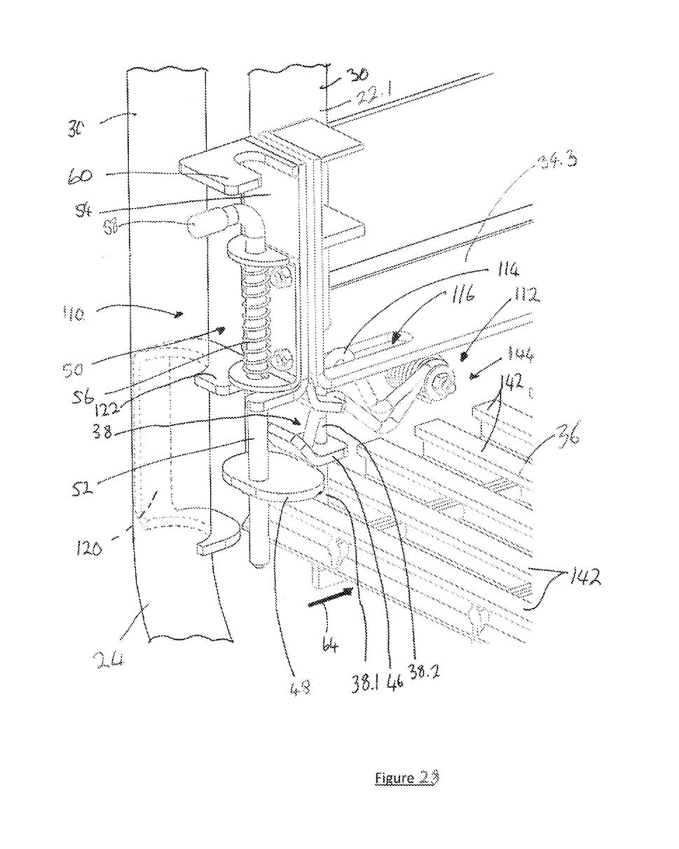

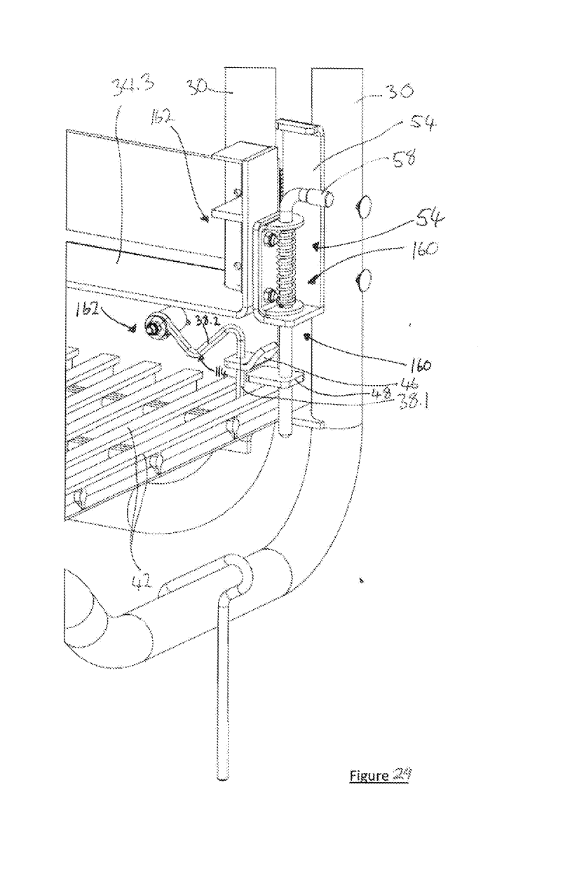

In FIG. 29 there is shown further detail of an exemplary embodiment of a manipulating assembly 160 and a floor locking assembly 162. With reference to the preceding drawings, particularly FIGS. 6 to 10 and 26, like reference numbers refer to like parts, unless otherwise specified.

The manipulating assembly 160 is the similar to the manipulating assembly 110, with the main difference being the difference in configuration of the bracket 54 of the manipulating assembly 160. The locking assembly 162 is similar to the locking assembly 112, with the main difference being that the connecting portion 38.2 of the obstruction member has a relatively lower profile. A slot 116 in the web 34.3 is not necessary with the manipulating assembly 160, as the dogleg 114 is accommodated below the web 34.3.

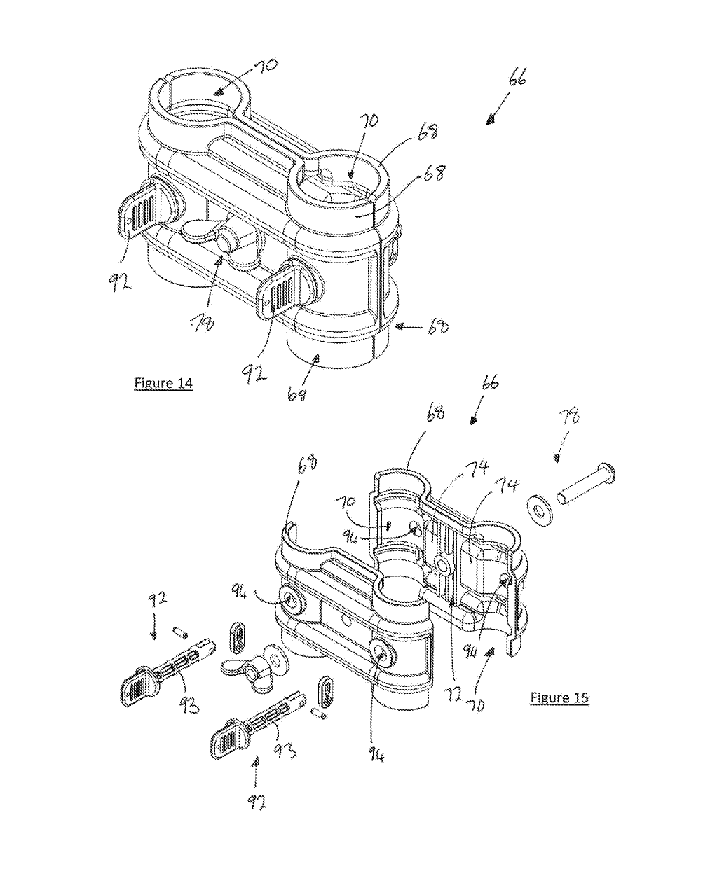

FIGS. 14 and 15 generally indicate, with reference numeral 66, a hinge assembly for connecting the panel assemblies 22 together. The hinge assembly 66 includes a pair of tube clamp members 68 that are substantially identical.

Each clamp member 68 includes a pair of tube clamp formations 70. The formations 70 correspond with profiles of the side rails 30. A bridge 72 interconnects the formations 70. The bridge 72 includes raised abutment formations 74. The bridge 72 defines an opening to receive a shank of a suitable fastener such as the wing-nut assembly 78 as shown in FIG. 15. The formations 74 are dimensioned and configured so that the corresponding abutment formations 74 can bear against each other when the assembly 66 is tightened, so avoiding an excessive clamping effect on adjacent side rails 30, which would inhibit pivotal movement of those side rails 30 with respect to each other.

The hinge assembly 66 includes two selectively removable keys 92. Each key 92 has a shank 93. Each tube clamp formation 70 has a central hole 94 for receiving the shank 93 of a respective key 92. Similarly, the rails 30 have corresponding holes for receiving the shank 93 of a key 92. When the rails 30 are clamped by a hinge assembly 66, the side rails 30 can be pivoted so that the holes in the rails 30 align with the holes in the clamp formations 70 to form a passage for receiving the shank 93 of a key 92. By inserting the key 92 into the passage formed by aligning the holes in a side rail 30 with the holes in a tube clamp formation 70, the side rail 30 is locked into position in the hinge assembly 66. The keys 92 thus restrict hinging of the rails 30 in the hinge assembly 66 when inserted into the passage. It follows that removing a key 92 from the passage enables the rail 30 to hinge or pivot relative to the hinge assembly 66.

It will be appreciated that the hinge assemblies 66 are configured to facilitate simple removal and replacement of the panel assemblies 22.

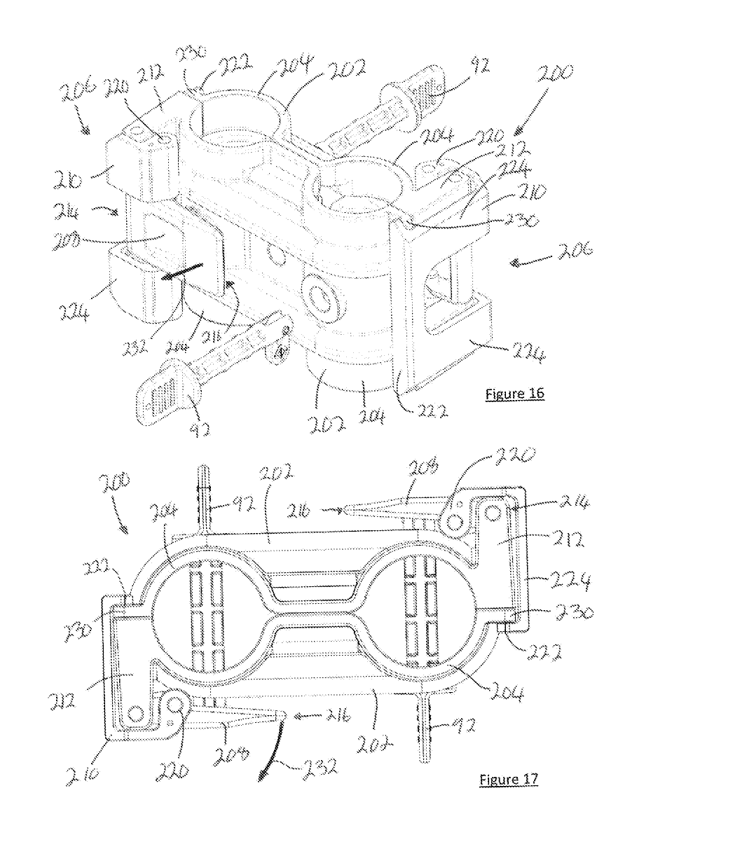

FIGS. 16 and 17 generally indicate, with reference numeral 200, a further exemplary embodiment of a hinge assembly for connecting the panel assemblies 22 together. With reference to FIGS. 16 and 17, like reference numerals refer to like parts in FIGS. 14 and 15, unless otherwise specified. The hinge assembly 200 is similar to the hinge assembly 66, with the main difference being the wing-nut assembly 78 of hinge assembly 66 substituted by hinged locking mechanisms 202 of hinge assembly 200.

The hinge assembly 200 includes a pair of tube clamp members 202 that are substantially identical.

Each tube clamp member 202 includes a pair of tube clamp formations 204. The formations 204 correspond with profiles of the side rails 30. A bridge 72 interconnects the formations 204.

Each tube clamp member 202 includes a locking mechanism 206 along one side thereof. The locking mechanism 206 comprises a tab 208 and a clasp formation 210.

The tab 208 is hingedly connected to arms 212 of the clamp member 202. The arms 212 are integrally formed with, and rigidly connected to, one of the tube clamp formations 204 of the tube clamp member 202. The tab 208 has a hinged end 214, hingedly connected to the arms 212, and a distal end 216.

The clasp formation 210 comprises hinge points 220, a grip formation 222, and two arms 224 extending between the hinge points 220 and the grip formation 222. The clasp formation 210 is hingedly connected, at the hinge points 220, to the tab 208 at a point intermediate the tab's hinged end 214 and distal end 216.

The clasp formation 210 of one tube clamp member 202 is operable to engage a lip 230 of the other tube clamp member 202 to clamp the tube clamp members 202 to each other. More specifically, the grip formation 222 of the clasp formation 210 abuts the lip 230 to clamp the tube clamp members 202 to each other.

The tab 208 is manipulated to lock and unlock the clasp formation 210 of one clamp member 202 to another clamp member 202. In a locked condition of the hinge assembly 200, as shown in FIG. 17, the tabs 208 are in a position wherein grip formation 222 of each clasp formation 210 is urged against the lip 230 of the opposite clamp member 202, to keep the clamp members 202 locked to each other. The locking mechanism 206 is configured so that the tab 208 is in an “over centre” condition when the clasp formation 210 locks one clamp member 20 to the other. The hinge assembly 200 will thus remain in the locked condition until the tabs 208 are purposively hinged away in the direction indicated by arrow 232, releasing the clasp formation 210 from the lip 210.

A number of ground engaging members in the form of pegs 98 are provided to retain the barricade systems 10 in position. Each of the pegs 98 includes an elongate portion 100 that can be driven into the ground while a retaining portion or arm 102 can engage the bottom rail 28. The arm 102 can be shaped at 106 (FIG. 11) so that a tool can be used to hook on to the arm 102 to extract the portion 100 from the ground.

The bottom rails 28 are shaped to define skids 104 to facilitate adjustment of the systems 10 once positioned.

It will readily be appreciated that the panel and gate assemblies 22, 24 can be folded up into a generally flat configuration as shown in FIGS. 12 and 13. Since the floor panels 36 are also generally flat, substantially the entire system 10 can be packaged in a form in which a significant amount of space saving can occur.

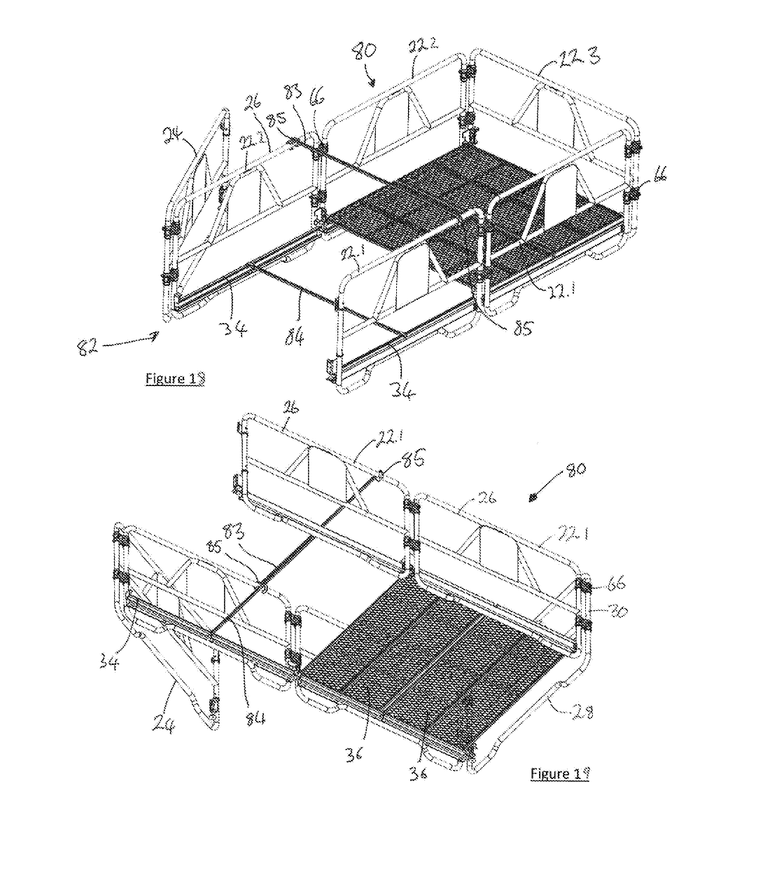

In FIGS. 18 and 19, there is shown a further exemplary embodiment of a barricade system 80. With reference to the preceding drawings, like reference numerals refer to like parts, unless otherwise specified.

The barricade system 80 is suitable for barricading an elongated area, such as a trench or other elongate excavation or area that needs guarding. In this exemplary embodiment, one or more further pairs of side panel assemblies 221.1, 22.2 are pivotally connected to an existing pair of side panel assemblies, thus providing a generally elongate barrier assembly 82 when erected.

It will be appreciated that adding the side panel assemblies 22.1, 22.2 is a relatively simple matter when using the hinge assemblies 66. Thus, the barrier assembly 82 can be repeatedly lengthened as a particular task is carried out. Instead, the barrier assembly 82 can be set up with a suitable length to suit the particular area.

Further, in this exemplary embodiment, when the side panel assemblies 22.2 are in their erected configuration or condition, two floor panels 36 are located in position with the gate assembly 24 open, as shown in FIG. 18. It will be appreciated that in this exemplary embodiment, the floor panels 36 are not simply slid into position as with the previous embodiment 10. Rather, it is normally required to drop the panels 36 into position and manipulate them so that the skid rails 37 can be received on the upper web 34.3 of the support structure 34, to be supported by the support structure 34. Thus, in order to remove the panels 36, it is normally required to lift one of the panels 36 off the support structure 34 before the other panels 36 can be removed. This can help the barricade assembly 80 to remain in its erected configuration while the panels 36 are in position.

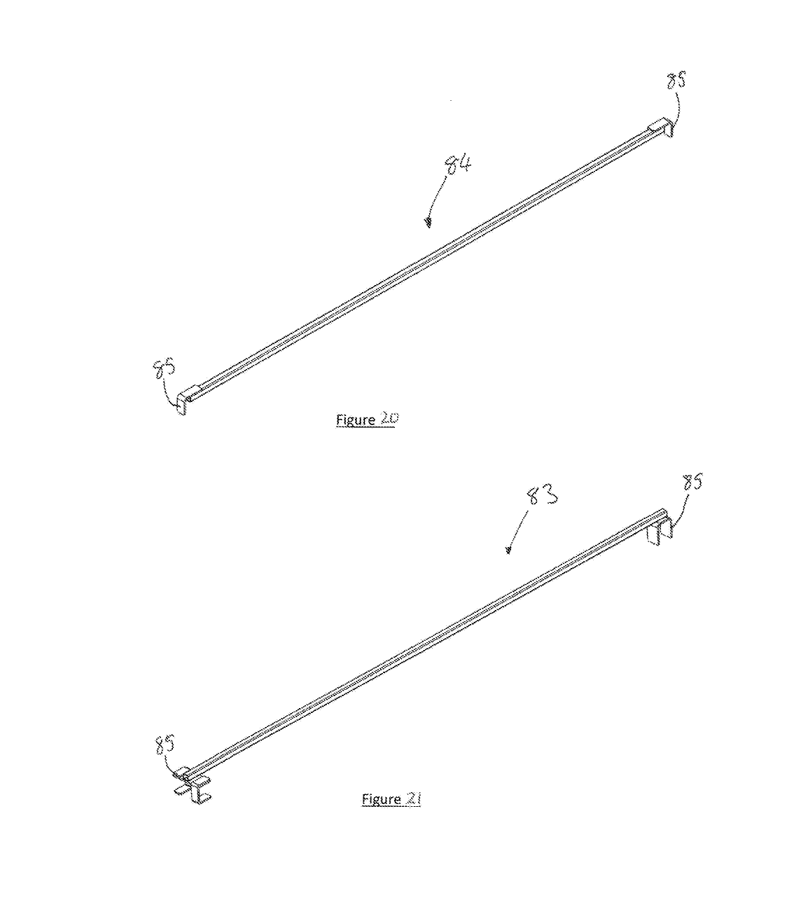

The barricade system 80 includes an upper stiffener 83 and a lower stiffener 84. The stiffeners 83 and 84 are shown in more detail in FIGS. 20 and 21, respectively. The stiffeners 83, 84 comprise elongate tubes having attachment formations 85 at their opposite ends. The attachment formations 85 of the upper stiffener 83 are configured to grip respective top rails 26 of opposite side panel assemblies 22.1, 22.2. The attachment formations 85 of the lower stiffener 84 are configured to grip respective floor support structures 34 of opposite side panel assemblies 22.1, 22.2. The stiffeners 83, 84 extend between the side panel assemblies 22.1, 22.2, as shown on FIGS. 18 and 19, when installed between the respective top rails 26 and floor support structures 34. The stiffeners 83, 84 prevent movement of the side panel assemblies 22.1, 22.2 relative to each other when installed.

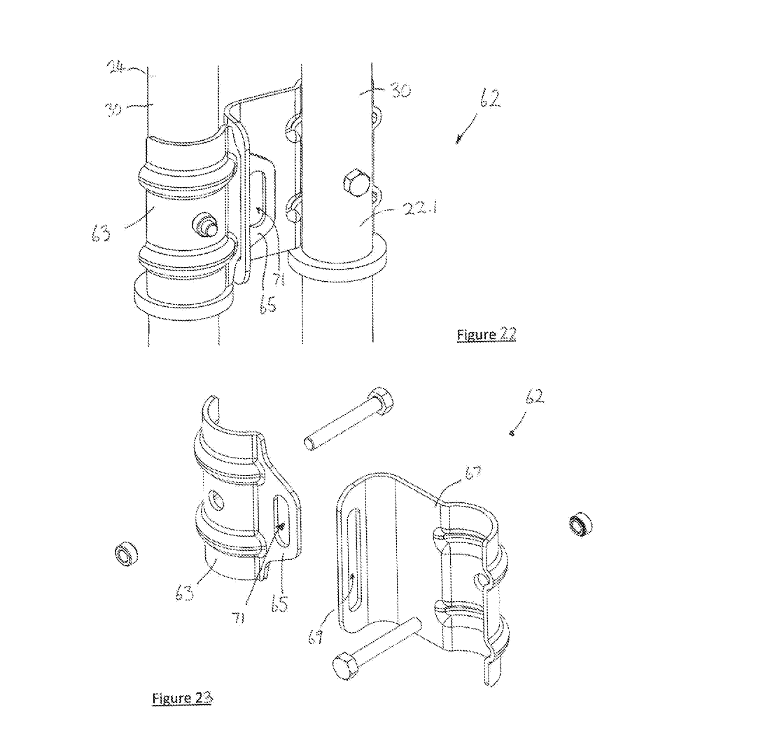

FIGS. 22 and 23 show more detail of the latch mechanism 62 of the systems 10, 80. The latch mechanism 62 comprises a bracket 63 with a tab 65, and a bracket 67 with a slot 69 for receiving the tab 65. The bracket 63 is fixed to a side rail 30 of the gate assembly 24 with a nut-and-bolt assembly. The bracket 67 is fixed to a side rail 30 of the side panel assembly 22.1 with a nut-and-bolt assembly. When the gate assembly 24 is closed (FIGS. 1 to 5), the tab 65 of the bracket 63 is received in the slot 69 of the bracket 67 and projects past the slot 69. The tab 65 has an aperture 71 therein for receiving the shackle of a padlock (not shown), thereby to lock the bracket 63 to the bracket 67, effectively locking the gate assembly 24 closed to the side panel assembly 22.1.

The systems 10, 80 can be of a number of different materials. For example, they can be predominantly of aluminium, steel or reinforced plastics. When provided in steel, the steel can be hot dip galvanised. A plastics material or other non-conductive material of suitable structural integrity would be useful in areas where electrical conductivity is undesirable.

In the erected configuration of both systems 10, 80, the side panel assemblies 22.1, 22.2 are generally at right angles to the front panel assembly 22.3 and the gate assembly 24. The side panel assemblies 22.1, 22.2 are locked in the right angle orientation to the front panel assembly 22.3 and the gate assembly 24 by the keys 92 of the hinge assembly 66. Both the bracket 54 and the locating member 88 define abutment surfaces or formations 106 that bear against each other when the panel assemblies are pivoted into the erected configuration and are generally at right angles or square. This helps an operator to position the panel assemblies prior to positioning the floor panels 36.

In FIG. 26, there is shown a further exemplary embodiment of a barricade system 124. With reference to the preceding drawings, like reference numerals refer to like parts, unless otherwise specified.

The barricade system 124 includes a supplementary support assembly in the form of a plurality of beams 125. The beams 125 are provided to support the floor panels 36. A locating member 126 extends generally at right angles from an end of each beam 125. The locating member 126 includes an arm 127 and a nesting or clipping formation 128 on an end of the arm 127. The beams 125 are configured to extend across the enclosure 14 with ends resting on the channel section 34. The arm 127 and the nesting formation 128 are configured so that the intermediate rail 32 can be received in the nesting formation 128.

As can be seen in the drawings, two floor panels 36 are provided between each pair of side panel assemblies 22.1, 22.2. Thus, it is normally required to support adjacent edges of corresponding floor panels 36. To that end, each intermediate rail 32 of the side panel assemblies 22.1 defines a locating formation 129 to locate a nesting formation 128 centrally with respect to the side rails 30 so that the adjacent edges can be supported on the associated beam 125.

A locating formation 123 is positioned on each side rail 30 of the side panel assemblies 22.2 to receive corners of the floor panels 36. Thus, the floor panels 36 are supported in the locating formations 123 and on the beams 125, in this exemplary embodiment.

Further, in this exemplary embodiment, when the side panel assemblies 22.1, 22.2 are in their erected configuration or condition, the floor panels 36 are located in position with the gate assembly 24 open, as shown in FIG. 26. It will be appreciated that in this exemplary embodiment, the floor panels 36 are not simply slid into position as with the previous embodiment. Rather, it is normally required to drop the panels 36 into position and manipulate them so that they can be received on the beams 125 and in the respective locating formations 123. Thus, in order to remove the panels 36, it is normally required to lift one of the panels 36 of the beams 125 before the panels 36 can be removed. This can help the barricade system 124 to remain in its erected configuration while the panels 36 are in position. Also, even when the gate assembly 24 is open, sliding of the panels 36 out of position is inhibited due to the locating formations 123.

With reference to the barricade system 10, the locating formations 123 form part of the floor support structures 34. The locating formations 123 extend upwardly from opposite ends of the upper web 34.3 of the floor support structure 34 of the barricade system 10.

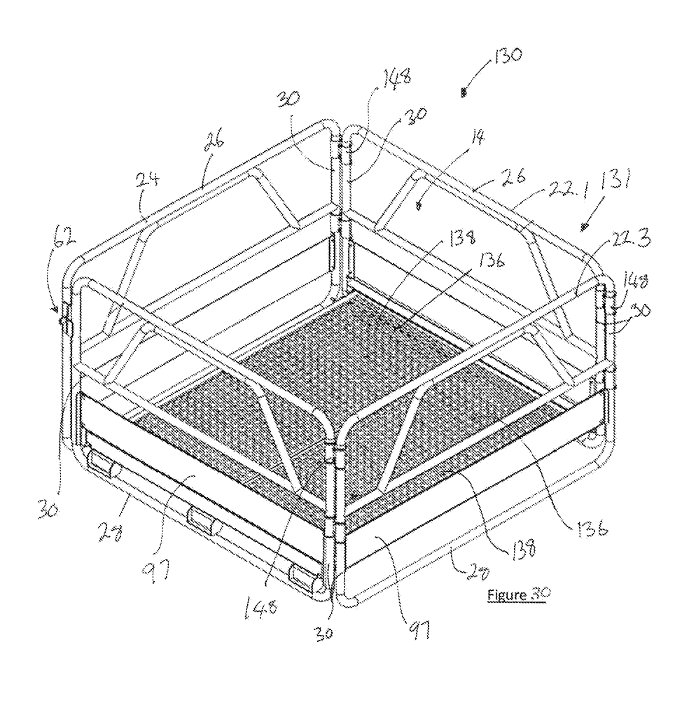

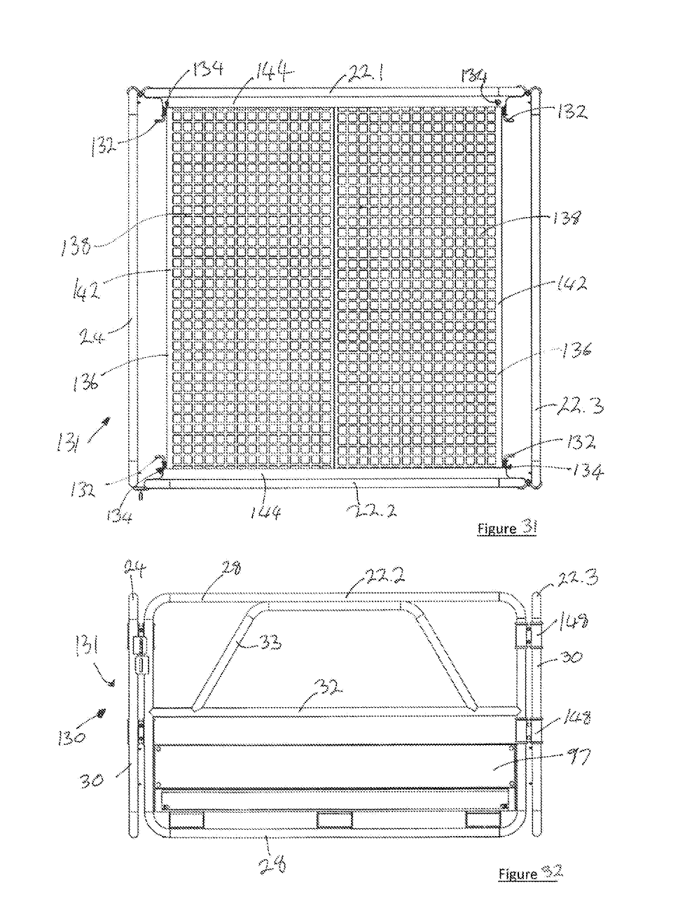

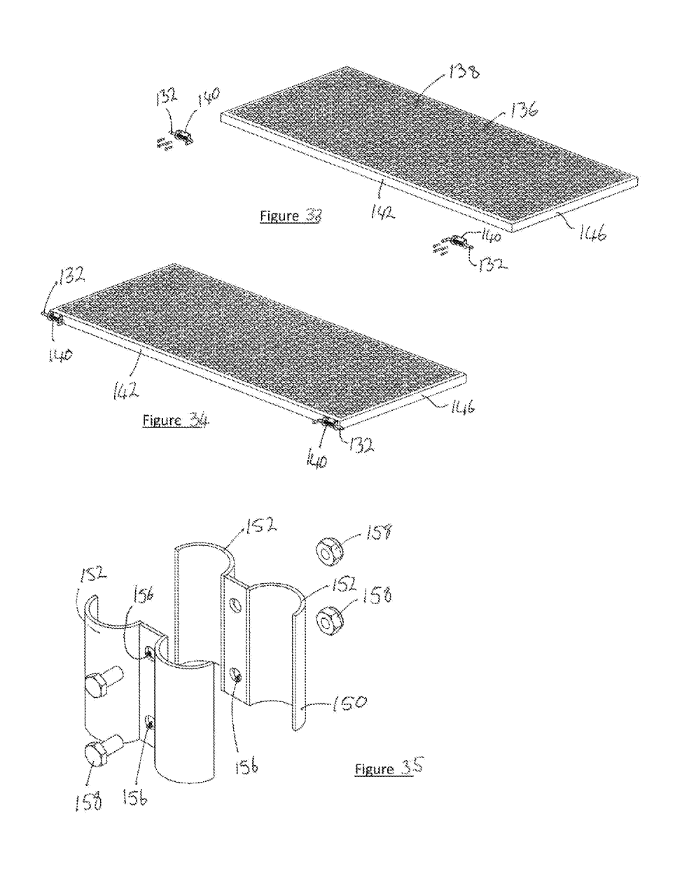

In FIGS. 30, 31 and 32, a further exemplary embodiment of a barrier system 130 is shown. With reference to the preceding drawings, like reference numerals refer to like parts, unless otherwise specified.

The barrier system 130 illustrates that a number of different types of floor locking and manipulating assemblies can be used to achieve a similar functionality to that achieved with the systems 10, 80. For example, in the system 130, the floor assembly 16 includes two floor panels 136. Each floor panel 136 is moulded of a material such as a plastics material, a fibreglass material/composite or a product of a pultrusion process. Each panel 136 is moulded or otherwise formed to define a grate 138 suitable for supporting personnel.

An elongate kick plate or panel 97 extends between the side rails 30 of the front panel assembly 22.3 and the side panel assemblies 22.1, 22.2.

Two spring-loaded bolts or latches 132 (FIG. 33, 34) are mounted with a suitable bracket 140 on an operatively outer side 142 of each panel 136. The latches 132 cooperate with suitable formations or members generally indicated at 134 on the side panel assemblies 22.1, 22.2. Furthermore, the bolts or latches 132 and members or formations 134 can be configured so that a resulting latch mechanism is only operable when a barrier assembly 131 of the system 130 is in its erected configuration. More particularly, the latches 132 can only engage the members or formations 134, when the barrier assembly 131 is in its erected configuration.

For example, each side panel assembly 22.1, 22.2 has a channel member or channel 144 in which sides 146 of the floor panels 136 can be received to support the floor panels. In this embodiment, the bolts or latches 132 can engage with openings defined in the channel 144 to retain the floor panels 136 in the channel 144.

FIG. 35 shows an alternative embodiment of a hinge assembly 148 used with the system 130. The hinge assembly 148 includes a pair of tube clamp members 150. Each tube clamp member 150 includes two tube clamp formations 152 interconnected with a bridge formation 154. The bridge formations 154 define corresponding openings 156 so that the clamp members 150 can be fastened together at the bridge formations 154 with suitable fasteners 158. The bridge formations 154 are configured so that an excessive clamping force on the side rails 30 is avoided.

In the various exemplary embodiments described above, two floor panels are described corresponding with each pair of side panel assemblies. However, it will readily be appreciated that a single floor panel and correspond with each pair of side panel assemblies. Alternatively, more than two floor panels can correspond with each pair of side panel assemblies.

It will be appreciated that the system 10, 80 is useful for protecting personnel both in and out of the enclosure. For example, the system 10, 80 can be provided with visual and/or audible warning systems to warn members of the public to remain out of the enclosure. This can also serve to protect personnel in the enclosure against accidents, for example, by vehicles being driven into the area which is protected.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:
a. there is no requirement for the inclusion of any particular described or illustrated characteristic, function, activity, or element, any particular sequence of activities, or any particular interrelationship of elements;
b. no characteristic, function, activity, or element is “essential”;
c. any elements can be integrated, segregated, and/or duplicated;
d. any activity can be repeated, any activity can be performed by multiple entities, and/or any activity can be performed in multiple jurisdictions; and
e. any activity or element can be specifically excluded, the sequence of activities can vary, and/or the interrelationship of elements can vary.

The use of the terms “a”. “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms meaning “including, but not limited to,”) unless otherwise noted.

Accordingly, every portion (e.g., title, field, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. A barricade system comprises
a collapsible barrier assembly that defines an enclosure when erected;
a floor assembly that is configured for location within the enclosure and removal from the enclosure when the barrier assembly is erected such that the floor assembly spans the enclosure, in use, the barrier assembly being configured to support the floor assembly when erected;
at least one releasable floor locking assembly that is capable of operative engagement with the barrier assembly and floor assembly and operable between a locked condition in which the floor assembly is locked to the barrier assembly and an unlocked condition in which the floor assembly can be removed from the enclosure; and
at least one manipulating assembly configured for engagement with the floor locking assembly to permit a user to operate the floor locking assembly to unlock the floor assembly, the manipulating assembly and floor locking assembly being configured so that engagement of the manipulating assembly with the floor locking assembly is substantially limited to a condition in which the barrier assembly is erected and access to the enclosure is inhibited.

2. A barricade system as claimed in claim 1, in which the barrier assembly includes four panel assemblies that are hinged together so that the barrier assembly can be collapsed into a generally flat condition for storage or transport.

3. A barricade system as claimed in claim 2, in which at least one of the panel assemblies includes a floor support structure defining a channel in which a side of the floor assembly can be received, when the barrier assembly is erected, the floor locking assembly operable to obstruct an opening to the channel in the locked condition of the floor locking assembly.

4. A barricade system as claimed in claim 3, in which one of the panel assemblies is a gate assembly so that controlled access to the enclosure is facilitated.

5. A barricade system as claimed in claim 4, which includes one releasable floor locking assembly and one corresponding manipulating assembly.

6. A barricade system as claimed in claim 4, which includes two or more releasable floor locking assemblies and two or more corresponding manipulating assemblies.

7. A barricade system as claimed in claim 5, in which each panel assembly includes a top rail, a bottom rail, a pair of side rails and an intermediate rail extending between the side rails.

8. A barricade system as claimed in claim 7, in which the manipulating assembly is positioned on a side rail to engage with the locking assembly when the panel assembly carrying the floor support structure and the panel assembly carrying the manipulating assembly are correctly oriented with respect to each other.

9. A barricade system as claimed in claim 8, in which the floor support structure extends between side rails relatively close to the bottom rail.

10. A barricade system as claimed in claim 9, in which the floor assembly comprises at least one floor panel, the floor panel(s) being in the form of rectangular grate panel(s).

11. A barricade system as claimed in claim 10, in which the locking assembly includes an obstruction member such as a catch, pawl, dog or the like that is displaceable between an operative position in which it is received in a position obstructing a path for the floor panel to be released from the floor support structure and an inoperative position in which the obstruction member is lifted clear from the path.

12. A barricade system as claimed in claim 11, in which the locking assembly includes a biasing member which biases the obstruction member to the operative position.

13. A barricade system as claimed in claim 12, in which an engagement formation or member extends from the obstruction member to engage with a complementary engagement formation or member of the manipulating assembly so that the manipulating assembly can be used to urge the obstruction member into the inoperative position.

14. A barricade system as claimed in claim 13, in which the manipulating assembly includes a handle assembly that is mounted on an associated side rail in a displaceable manner, the handle assembly including an elongate member, such as a rod that is mounted on, and displaceable with respect to, a bracket that is itself fastened to the side rail.

15. A barricade system as claimed in claim 14, in which the complementary engagement formation or member extends from the elongate member to engage the engagement member that extends from the obstruction member, the bracket being mounted on the side rail such that if an associated panel moves out of its erected position, which is generally at right angles to an adjacent panel carrying the support structure, the engagement members can no longer engage each other.

16. A barricade system as claimed in claim 9, in which a supplementary support assembly extends between side panel assemblies to support the floor assembly in a location or orientation above the floor support structure.

17. A barricade system as claimed in claim 16, in which the supplementary support assembly is in the form of a series of beams that can optionally be positioned across the enclosure and between the side panel assemblies.
